(19) United States
(12) Patent Application Publication
(10) Pub. No.: US 2002/0009634 A1
(43) Pub. Date: Jan. 24, 2002

(54) Sealed battery

(75) Inventor: Tetsuhiro Oogaku, Utsunomiya-Shi (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: NEC MOBILE ENERGY CORPORATION, Utsunomiya-Shi (JP)

(21) Appl. No.: 09/828,220

(22) Filed: Apr. 9, 2001

(30) Foreign Application Priority Data
Apr. 10, 2000 (JP) 2000-107789

(51) Int. Cl. H01M 2/30; H01M 2/08; H01M 2/26

(52) U.S. Cl. 429/180; 429/208; 429/211; 429/181

(57) ABSTRACT

The present invention provides a battery, which maintains stable conductive connection between an electrode guiding pin and an electrode pulling member. The invention provides a sealed battery, which comprises an insulating member with a through-hole, said insulating member is placed on an opening of a planar member, an electrode guiding pin connected in conductive manner to a power generating element is passed through said through-hole and caulked and fixed, whereby an electrode pulling member is placed on the insulating member, and the electrode pulling member is connected in conductive manner with the electrode guiding pin by welding.

### BACKGROUND OF THE INVENTION

The present invention relates to a sealed battery, and in particular, to a nonaqueous electrolyte battery, which comprises an electrode terminal unit of sealing structure and having superb conductive connection property.

Various types of batteries are now used as power sources for small-size electronic devices. A sealed battery of small size and large capacity is used. Lithium battery of high capacity or nonaqueous electrolyte battery such as lithium ion secondary battery are widely used.

To cope with smaller size of the devices, in addition to cylindrical type battery, rectangular battery is now widely used, which can effectively utilize smaller space. In the rectangular battery, a battery case serves as one of the electrodes of the battery and an electrode terminal separated from the battery case by an insulating material is mounted.

FIG. 3 is a perspective view of an example of a rectangular battery.

In a battery case 1 designed in shape of quadratic prism and made of stainless steel, soft steel with nickel-plated surface, etc., a power generating element is accommodated. The power generating element is produced by winding up a combination of a positive electrode and a negative electrode laminated one upon another with a separator between them. On an upper end 2 of the battery case 1, a header 6 with an electrode guiding pin 5 is mounted on an opening formed on a metal plate 3 and it is welded with an insulating member 4.

FIG. 4 represents drawings to explain an example of a header, showing cross-section of upper portion of the battery. FIG. 4 (A) is an exploded perspective view of component parts of the header, and FIG. 4 (B) is a cross-sectional view of the header when it is assembled.

In a header 6, a positive electrode guiding pin 5 made of metal with good conductivity such as aluminum or aluminum alloy is placed in a through-hole of an insulating member 4 in such manner that it is not connected in conductive manner with the metal plate 3. The insulating member 4 comprises an upper insulating member 4A and a lower insulating member 4B. On the upper insulating member 4A, an electrode pulling member 7 is mounted. As the electrode pulling member 7, a material such as nickel plate, nickel-plated iron plate, copper plate, german silver plate, etc. is used. The electrode guiding pin 5 is connected in conductive manner with the electrode pulling member 7 by caulking the electrode guiding pin 5. This is also helpful to maintain and to tightly put together the metal plate 3, the insulating members 4A and 4B, the electrode guiding pin 5, and the electrode pulling member 7.

On the lower portion of the electrode guiding pin 5, a positive electrode tab 9 protected by an insulator 8 made of a material such as polyimide, fluoro-resin, etc. is connected in conductive manner.

As described above, sealing structure of the battery is assured by caulking positive electrode or negative electrode guiding pin and by integrating the electrode header and by sealing the component parts. However, problems may arise in that sealing is not tight enough between the electrode guiding pin and the electrode pulling member.

It is an object of the present invention to provide a sealed battery, which has an electrode sealing structure maintained by caulking and sealing the electrode guiding pin and ensures good conductive connection between the electrode guiding pin and the electrode pulling member, and which also exhibits less changes of conductive connection over time.

### SUMMARY OF THE INVENTION

The present invention provides a sealed battery, which comprises an insulating member with a through-hole, said insulating member is placed on an opening of a planar member, an electrode guiding pin connected in conductive manner to a power generating element is passed through said through-hole and caulked and fixed, whereby an electrode pulling member is placed on the insulating member, and the electrode pulling member is connected in conductive manner with the electrode guiding pin by welding.

The present invention provides a sealed battery as described above, wherein the electrode guiding pin is made of aluminum or aluminum alloy, and the electrode pulling member is made of nickel or nickel alloy.

Further, the present invention provides a sealed battery as described above, wherein welding is performed by resistance welding.

Also, the present invention provides a sealed battery as described above, wherein the battery is a lithium ion secondary battery.

### BRIEF DESCRIPTION OF THE DRAWINGS

FIG. 1 represents drawings to explain a header unit to be mounted on a top opening of a battery case of a sealed battery according to the present invention;

FIG. 2 represents drawings to explain another embodiment of the sealed battery of the present invention;

FIG. 3 is a perspective view of an example of a rectangular battery; and

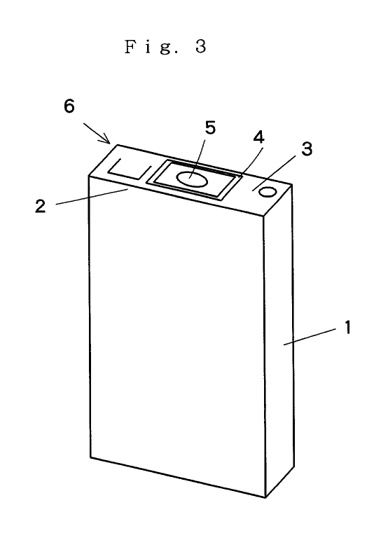

FIG. 4 shows drawings to explain an example of a header.

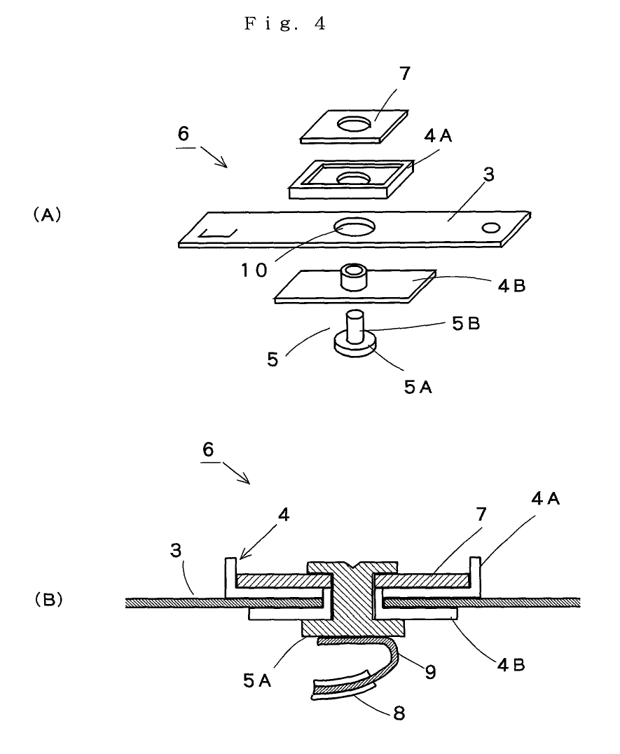

### DETAILED DESCRIPTION OF THE PREFERRED EMBODIMENT

The present invention is characterized by a sealing structure between an electrode guiding pin and an electrode pulling member of a header of a sealed battery. Conductive connection between the electrode guiding pin and the electrode pulling member is maintained not by the contact between these two components but by welding connection of the components. This provides better conductive connection and reduces the changes of the contact over time.

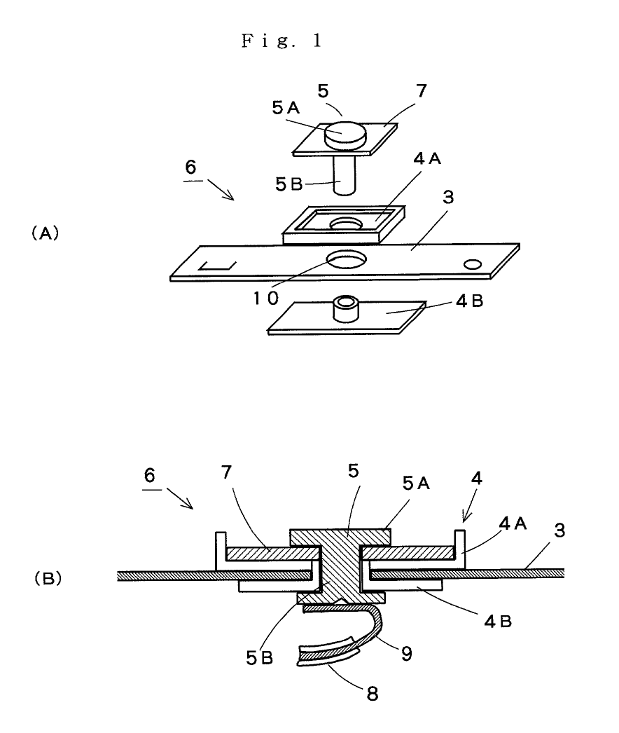

FIG. 1 represents drawings to explain a header unit to be mounted on a top opening of a battery case of a sealed battery of the present invention. FIG. 1(A) is an exploded perspective view of component parts, and FIG. 1(B) is a cross-sectional view of the header unit.

A header 6 comprises a metal plate 3. An insulating member 4 comprising an upper insulating member 4A and a lower insulating member 4B is mounted on an opening 10 of the metal plate 3. An electrode guiding pin 5 is made of metal having good conductivity such as aluminum or aluminum alloy, and an electrode pulling member 7 is made of nickel plate, or nickel-plated iron plate, copper plate, or german silver plate. A collar 5A of the electrode guiding pin 5 is connected with the electrode pulling member 7 by resistance welding. Columnar part 5B is passed through the opening of each of the upper insulating member 4A and the lower insulating member 4B. Then, the end of the columnar part 5B of the electrode guiding pin 5 is caulked and deformed to integrally connect. A positive electrode tab 9 protected by an insulator 8 made of a material such as polyimide, fluoro-resin, etc. is welded to the caulked portion of the columnar part 5B of the electrode guiding pin 5.

For the welding of the electrode pulling member 7 to the collar 5A of the electrode guiding pin 5, laser welding may be applied instead of resistance welding.

The insulating member may be separated to two members, i.e. an upper insulating member and a lower insulating member, or it may be produced by integrally molding metal plate and synthetic resin.

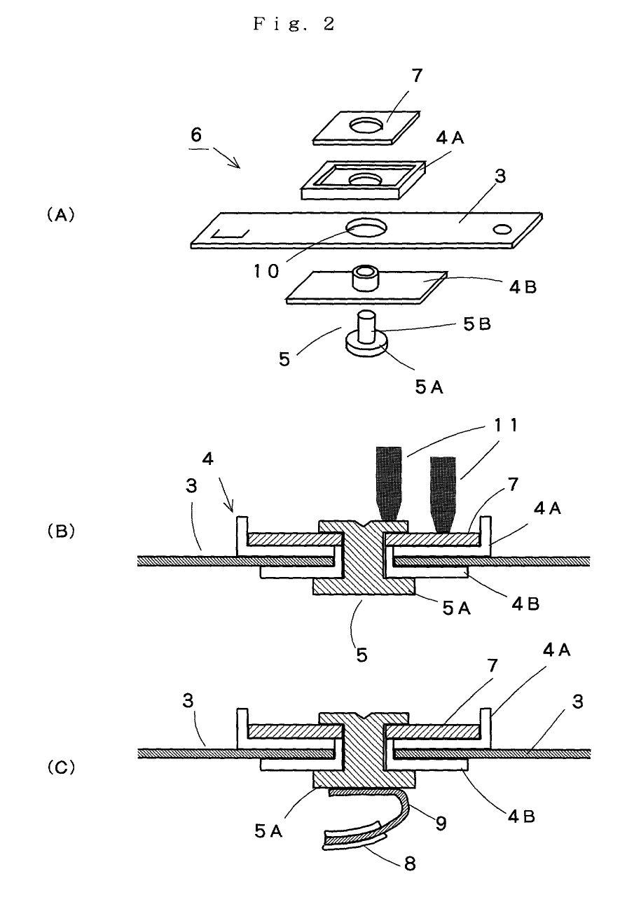

FIG. 2 represents drawings to explain another embodiment of a sealed battery of the present invention. FIG. 2(A) is an exploded perspective view to explain the component parts. FIG. 2(B) and FIG. 2(C) each represents assembling process.

A header 6 comprises a metal plate 3. An insulating member 4 comprising an upper insulating member 4A and a lower insulating member 4B is mounted on an opening 10 of the metal plate 3. An electrode guiding pin 5 is made of metal having good conductivity such as aluminum or aluminum alloy, and an electrode pulling member 7 is made of nickel plate, or nickel-plated iron plate, copper plate, or german silver plate. A collar 5A of the electrode guiding pin 5 is connected with the electrode pulling member 7 by resistance welding. Columnar part 5B is passed through the opening of each of the upper insulating member 4A and the lower insulating member 4B. Then, the end of the columnar part 5B of the electrode guiding pin 5 is caulked and deformed to integrally connect. Then, as shown in FIG. 2(B), electrodes for welding 11 are pressed on the electrode guiding pin 5 and the electrode pulling member 7, and electric power is turned on to connect the collar of the electrode guiding pin 5 with the electrode pulling member 7 by resistance welding. Then, as shown in FIG. 2 (C), a positive electrode tab 9 protected by an insulator 8 made of a material such as polyimide, fluoro-resin, etc. is welded to the collar of the electrode guiding pin 5 to achieve conductive connection with the header.

To connect the electrode guiding pin with the electrode pulling member, laser welding may be applied instead of resistance welding. In case of resistance welding, heat is generated on contact surface of metal to be welded. In laser welding, welding is performed by heating and melting caused by thermal energy of the laser beam irradiated from outside, and the insulating member may be heated and deteriorated. Thus, it is necessary to avoid the influence of heat during heating to the insulating member.

The header of the present invention can be applied to various types of sealed battery. It is most preferably used for the manufacture of lithium ion battery. This battery is produced as follows: A positive electrode and a negative electrode, each containing active material to dope or undope lithium, are laminated one upon another via a separator between them, and the laminated electrodes are wound up to produce a battery element, and lithium ion battery is produced from the battery element. The header of the present invention is most preferably used for the manufacture of the battery, which has a battery case as a negative electrode and the electrode guiding pin as a positive electrode made of aluminum.

### Embodiments

Description will be given below on embodiments of the present invention.

### Example 1

An insulating member made of fluoro-resin having an opening to receive the electrode guiding pin was mounted on an opening of 2.6 mm in diameter at the center of a nickel-plated iron material in rectangular shape with long side of 33 mm and short side of 8 mm, using a planar member. Then, a nickel plate for the electrode pulling member of 0.3 mm in thickness and having an opening of 2.0 mm at the center was placed on the insulating member on outside of an assembled battery case. An electrode guiding pin made of aluminum and having a collar of 2.6 mm in diameter with a columnar part of 1.5 mm in diameter was inserted from a position on inner side of the assembled battery case. Caulking is performed from above and below to deform the electrode guiding pin and to integrally connect it.

Next, an electrode of 1.5 mm in diameter was pressed on the electrode guiding pin and the electrode pulling member. To perform AC resistance welding, electric current of 500 A was connected for 0.02 second. Thus, the electrode guiding pin and the electrode pulling member were welded together, and a battery header was prepared.

A lithium-manganese composite oxide, a conductive material and a binder were mixed together, and this was coated on an aluminum foil, and a positive electrode was prepared. Carbonaceous material was mixed and kneaded with the conductive material and the binder, and this was coated on a copper foil, and a negative electrode was prepared. On these electrodes, a positive electrode tab and a negative electrode tab were mounted respectively. Next, the positive electrode and the negative electrode were laminated one upon another with a separator placed between them and in the order of separator—negative electrode—separator—positive electrode. This was wound up, and a battery element was prepared. Next, the positive electrode tab and the negative electrode tab were welded on the electrode guiding pin of the battery header and on inner wall surface of the battery case. Then, the header was mounted on the battery case and welded. Next, by pouring electrolytic solution and by sealing, a battery in size of 48×34×8 mm (height×width×thickness) was produced.

On the battery thus produced, impedance between the electrode guiding pin and the electrode pulling member was measured. A droplet of the electrolytic solution was attached on boundary surface between the electrode guiding pin and the electrode pulling member, and impedance was measured after 500 hours. There was no change in impedance.

### Example 2

A battery was produced by the same procedure as in Example 1 except that the collar of the electrode guiding pin was welded with the electrode pulling member by AC resistance welding, and this was inserted into a through-hole of the insulating member from outside of the battery case after the battery was assembled, and it was caulked and integrally connected. The change in impedance was measured by the same procedure as in Example 1, and there was no change in impedance.

### Comparative Example 1

A battery was produced by the same procedure as in Example 1 except that the electrode guiding pin was not welded with the electrode pulling member. One thousand batteries were produced, and the test was performed by the same procedure as in Example 1. In 1% of the batteries, impedance was increased to 5 mΩ or more.

According to the sealed battery of the present invention, the electrode guiding pin is caulked, and conductive connection is achieved between the electrode guiding pin of the battery and the electrode pulling terminal. As a result, it is possible to produce a battery, which exhibits less changes of electric contact over time and which has stable characteristics.

What is claimed is:

1. A sealed battery, comprising an insulating member with a through-hole, said insulating member is placed on an opening of a planar member, an electrode guiding pin connected in conductive manner to a power generating element is passed through said through-hole and caulked and fixed, whereby an electrode pulling member is placed on the insulating member, and the electrode pulling member is connected in conductive manner with the electrode guiding pin by welding.

2. A sealed battery according to claim 1, wherein the electrode guiding pin is made of aluminum or aluminum alloy, and the electrode pulling member is made of nickel or nickel alloy.

3. A sealed battery according to claim 1, wherein the electrode guiding pin is connected with the electrode pulling member by welding prior to assembling.

4. A sealed battery according to claim 1, wherein welding is performed by resistance welding.

5. A sealed battery according to claim 2, wherein welding is performed by resistance welding.

6. A sealed battery according to claim 3, wherein welding is performed by resistance welding.

7. A sealed battery according to claim 1, wherein the battery is a lithium ion secondary battery.
